(19) United States
(12) Patent Application Publication
(10) Pub. No.: US 2016/0289428 A1
(43) Pub. Date: Oct. 6, 2016

(54) CELLULOSE-ESTER-RESIN-MODIFYING AGENT, CELLULOSE ESTER OPTICAL FILM, POLARIZING-PLATE PROTECTIVE FILM, AND LIQUID CRYSTAL DISPLAY APPARATUS

(71) Applicant: DIC Corporation, Tokyo (JP)

(72) Inventors: Miki OTA, Ichihara-shi (JP); Yusuke TAJIRI, Ichihara-shi (JP); Hiroshi YOSHIMURA, Ichihara-shi (JP)

(21) Appl. No.: 15/037,818

(22) PCT Filed: Nov. 6, 2014
(86) PCT No.: PCT/JP2014/079422

§ 371 Date: May 19, 2016

(30) Foreign Application Priority Data
Nov. 21, 2013 (JP) 2013-240844

(51) Int. Cl. C08L 1/14; B29D 11/00; G02F 1/1335

(52) U.S. Cl. CPC C08L 1/14; G02F 1/133528; B29D 11/00788; G02F 2201/50; B29K 2067/00

(57) ABSTRACT

An object of the present invention is to provide a modifying agent with which a film having a phase retardation that does not vary significantly due to variations in humidity and being highly transparent and suitable for optical applications can be produced, a resin composition including the modifying agent, an optical film produced using the composition, and a liquid crystal display apparatus including the optical film. Provided is a cellulose-ester-resin-modifying agent including a polyester resin (A) having a backbone skeleton including a structure represented by General Formula (1):

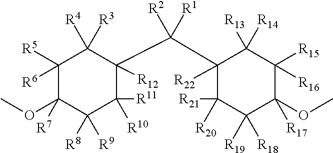

(where R¹ to R²² each represent a hydrogen atom, an alkyl group having 1 to 6 carbon atoms, a cycloalkyl group, or an aromatic group having 6 to 10 carbon atoms).

### TECHNICAL FIELD

The present invention relates to a cellulose-ester-resin-modifying agent that can be used in various applications including optical films such as a retardation film (e.g., polarizing-plate protective film) and to a cellulose ester optical film, a polarizing-plate protective film, and a liquid crystal display apparatus that include the modifying agent.

### BACKGROUND ART

Recently, various information appliances such as notebook computers, televisions, and mobile phones that include a liquid crystal display apparatus (LCD) capable of displaying images and characters with a high degree of definition have been introduced into the market at a high pace. Retardation films, which increase the viewing angles of LCDs and enable contrast enhancement, are important members for the information appliances. In order to enhance the functions of the retardation films, the optical anisotropy of the films (i.e., the phase retardation of the films) needs to be controlled.

Cellulose ester films have been used as a film having a phase retardation (i.e., retardation film). It is known that the phase retardations of cellulose eater films vary depending on moisture content, that is, the ambient humidity. If the phase retardation of a retardation film having a specific phase retardation varies depending on humidity, the viewing angle of an LCD and the color tone of the LCD which is observed when the LCD is viewed obliquely may be degraded. The variations in phase retardation due to variations in humidity increase with a reduction in the thickness of the film. This is one of the issues that arise with a reduction in the thickness of LCD members.

A known example of retardation films having a phase retardation that does not vary significantly depending on humidity is a film produced using a composition including a compound having a furanose structure or a pyranose structure and a cellulose ester resin (e.g., see PTL 1). However, the reduction in the variations in the phase retardation of the retardation film disclosed in PTL 1 due to variations in humidity is not sufficient.

### CITATION LIST

### Patent Literature

PTL 1: International Publication No. 2007/125764

### SUMMARY OF INVENTION

### Technical Problem

An object of the present invention is to provide a modifying agent with which a film including a cellulose ester resin, the film having a phase retardation that does not vary significantly due to variations in humidity and being highly transparent and suitable for optical applications, can be produced. Another object of the present invention is to provide a cellulose ester optical film, a polarizing-plate protective film, and a liquid crystal display apparatus that include the modifying agent.

### Solution to Problem

The inventors of the present invention conducted extensive studies and, as a result, found that, for example, the above-described issues may be addressed by using a modifying agent including a polyester resin having a backbone skeleton including a skeleton derived from a hydrogenated bisphenol A; and that the above-described issues may also be addressed by using a polyester resin including a hydrogenated bisphenol skeleton instead of a skeleton derived from a hydrogenated bisphenol A. Thus, the present invention was made.

Specifically, the present invention provides a cellulose-ester-resin-modifying agent including a polyester resin (A) having a backbone skeleton including a structure represented by General Formula (1) below:

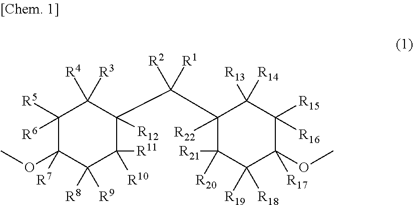

(where R¹ to R²² each represent a hydrogen atom, an alkyl group having 1 to 6 carbon atoms, a cycloalkyl group, or an aromatic group having 6 to 10 carbon atoms).

The present invention also provides a cellulose ester optical film including the above-described cellulose-ester-resin-modifying agent and a cellulose ester resin.

The present invention further provides a polarizing-plate protective film produced by casting a resin solution on a metal support; removing the organic solvent by distillation; and subsequently performing drying, the resin solution being prepared by dissolving the above-described cellulose-ester-resin-modifying agent and a cellulose ester resin in an organic solvent.

The present invention also provides a liquid crystal display apparatus including the polarizing-plate protective film.

### Advantageous Effects of Invention

According to the present invention, a modifying agent with which a film having a phase retardation that does not vary significantly due to variations in humidity and being highly transparent and suitable for optical applications can be produced may be provided. The film according to the present invention may be highly transparent and suitable for optical applications. Thus, the optical film having a phase retardation that does not vary significantly due to variations in humidity and being highly transparent may be suitably used as a polarizing-plate protective film, an optical compensation film, a retardation film, or the like.

According to the present invention, the film may be produced by a method in which a resin solution prepared by dissolving the cellulose-ester-resin-modifying agent and a cellulose ester resin in an organic solvent is cast on a metal support, the organic solvent is removed by distillation, and subsequently drying is performed (i.e., solvent casting). The film may also be produced by a method in which a composition including the cellulose-ester-resin-modifying agent and a cellulose ester resin is melt-kneaded with an extruder or the like and formed into a film with a T-die or the like (i.e., melt extrusion). Optionally, the film produced by the solvent casting method or the melt extrusion method described above may be stretched to form a stretched film. Various optical films such as a polarizing-plate protective film, an optical compensation film, and a retardation film can be produced by the above-described methods.

### DESCRIPTION OF EMBODIMENTS

A cellulose-ester-resin-modifying agent according to the present invention includes a polyester resin (A) including a structure represented by General Formula (1) below:

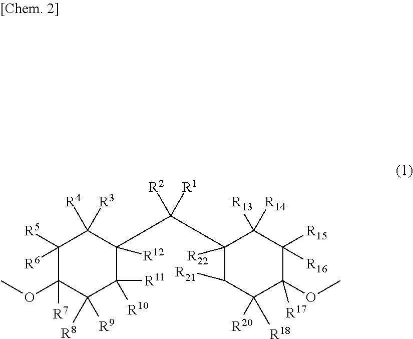

(where R¹ to R²² each represent a hydrogen atom, an alkyl group having 1 to 6 carbon atoms, a cycloalkyl group, or an aromatic group having 6 to 10 carbon atoms).

A cellulose-ester-resin-modifying agent according to the present invention with R¹ and R² in General Formula (1) above being each an alkyl group having 1 to 6 carbon atoms advantageously has good compatibility with a cellulose ester resin. A cellulose-ester-resin-modifying agent according to the present invention with R¹ and R² in General Formula (1) above being each a methyl group is more advantageous.

A cellulose-ester-resin-modifying agent according to the present invention with R³ to R²² in General Formula (1) above being each a hydrogen atom or an alkyl group having 1 to 6 carbon atoms advantageously has good compatibility with a cellulose ester resin. A cellulose-ester-resin-modifying agent according to the present invention with R³ to R²² in General Formula (1) above being each a hydrogen atom is more advantageous.

Thus, a cellulose-ester-resin-modifying agent according to the present invention with R¹ and R² in General Formula (1) above being each an alkyl group having 1 to 6 carbon atoms and R³ to R²² in General Formula (1) above being each a hydrogen atom or an alkyl group having 1 to 6 carbon atoms is advantageous. A cellulose-ester-resin-modifying agent according to the present invention with R¹ and R² in General Formula (1) above being each a methyl group and R³ to R²² in General Formula (1) above being each a hydrogen atom is more advantageous.

The cellulose-ester-resin-modifying agent according to the present invention may be produced, for example, by reacting a dihydric alcohol (a1) with a dibasic acid (a2). The dihydric alcohol (a1) includes a dihydric alcohol represented by General Formula (2) below:

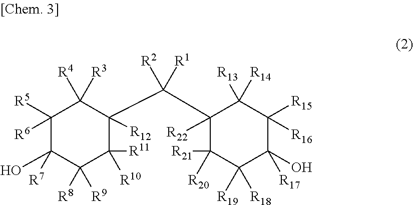

(where R¹ to R²² each represent a hydrogen atom, an alkyl group having 1 to 6 carbon atoms, a cycloalkyl group, or an aromatic group having 6 to 10 carbon atoms).

Examples of the dihydric alcohol represented by General Formula (2) above include hydrogenated bisphenol A, hydrogenated bisphenol AP, hydrogenated bisphenol B, hydrogenated bisphenol BP, hydrogenated bisphenol C, hydrogenated bisphenol E, hydrogenated bisphenol F, hydrogenated bisphenol G, hydrogenated bisphenol PH, and hydrogenated bisphenol Z.

The dihydric alcohol represented by General Formula (2) above may be a commercially available one or synthesized as needed. In the case where the dihydric alcohol represented by General Formula (2) above is synthesized, for example, the methods described in Japanese Unexamined Patent Application Publication Nos. 53-119854, 61-260034, 4-103548, and 6-329569 may be employed.

A dihydric alcohol represented by General Formula (2) above with R¹ and R² in General Formula (2) being each an alkyl group having 1 to 6 carbon atoms advantageously has good compatibility with a cellulose ester resin. A dihydric alcohol represented by General Formula (2) above with R¹ and R² in General Formula (2) being each a methyl group is more advantageous.

A dihydric alcohol represented by General Formula (2) above with R³ to R²² in General Formula (2) being each a hydrogen atom or an alkyl group having 1 to 6 carbon atoms advantageously has good compatibility with a cellulose ester resin.

Thus, a dihydric alcohol represented by General Formula (2) above with R¹ and R² in General Formula (2) being each an alkyl group having 1 to 6 carbon atoms and R³ to R²² in General Formula (2) being each a hydrogen atom or an alkyl group having 1 to 6 carbon atoms is advantageous. A dihydric alcohol represented by General Formula (2) above with R¹ and R² in General Formula (2) being each a methyl group and R³ to R²² in General Formula (2) being each a hydrogen atom (i.e., hydrogenated bisphenol A) is more advantageous.

The dihydric alcohol (a1) used in the present invention may further include dihydric alcohols other than the dihydric alcohol represented by General Formula (2) as long as the advantageous effects of the present invention are not impaired. The content of the dihydric alcohol represented by General Formula (2) in the dihydric alcohol (a1) is preferably such that the amount of dihydric alcohol represented by General Formula (2) is 5 to 100 parts by mass relative to 100 parts by mass of the dihydric alcohol (a1) and is more preferably such that the amount of dihydric alcohol represented by General Formula (2) is 15 to 100 parts by mass relative to 100 parts by mass of the dihydric alcohol (a1) in order to produce an optical film having a phase retardation that does not vary significantly due to variations in humidity.

Preferable examples of the other dihydric alcohols include aliphatic alcohols having 2 to 4 carbon atoms such as ethylene glycol, 1,2-propylene glycol, 1,3-propanediol, 2-methylpropanediol, 1,2-butanediol, 1,3-butanediol, 1,4-butanediol, and 2,3-butanediol. Among the above dihydric alcohols, ethylene glycol and 1,2-propylene glycol may be advantageously used in order to produce a cellulose-ester-resin-modifying agent with which sufficiently high resistance to moisture permeation can be imparted to a cellulose ester film. The above other dihydric alcohols may be used alone or in combination of two or more.

Examples of the dibasic acid (a2) include aliphatic dibasic acids and aromatic dibasic acids.

Examples of the aliphatic dibasic acids include aliphatic dibasic acids having 2 to 6 carbon atoms. Specific examples thereof include malonic acid, succinic acid, glutaric acid, adipic acid, maleic acid, and fumaric acid. The above aliphatic dibasic acids may be used alone or in combination of two or more.

Examples of the aromatic dibasic acids include phthalic acid, terephthalic acid, isophthalic acid, 1,5-naphthalenedicarboxylic acid, and 1,4-naphthalenedicarboxylic acid. The above aromatic dibasic acids may be used alone or in combination of two or more.

Among the above-described dibasic acids (a2), an aliphatic dibasic acid having 3 to 8 carbon atoms is preferably used in order to produce an optical film having a phase retardation that does not vary significantly due to variations in humidity. In particular, succinic acid and adipic acid are more preferably used.

The polyester resin (A) may be produced by esterification of the above-described raw materials, for example, at 180° C. to 250° C. for 10 to 25 hours. The esterification reaction may be conducted in the presence of an esterification catalyst as needed. The conditions under which the esterification reaction is conducted, such as temperature and duration, are not limited and may be set appropriately.

Examples of the esterification catalyst include titanium catalysts such as tetraisopropyl titanate and tetrabutyl titanate; tin catalysts such as dibutyltin oxide; and organic sulfonic acid catalysts such as p-toluenesulfonic acid.

The amount of esterification catalyst used may be set appropriately and is normally set to 0.001 to 0.1 parts by mass relative to 100 parts by mass of the total amount of raw materials.

The number-average molecular weight (Mn) of the polyester resin (A) is preferably 500 to 3,000 and is more preferably 500 to 1,500 in order to enhance the compatibility of the modifying agent with a cellulose ester resin.

The number-average molecular weight (Mn) of the polyester resin (A) is determined in terms of polystyrene on the basis of gel permeation chromatography (GPC). The GPC conditions are as follows.

### [GPC Conditions]

Equipment: High-speed GPC system “HLC-8320GPC” produced by Tosoh Corporation

Columns: “TSK GURDCOLUMN SuperHZ-L” produced by Tosoh Corporation
“TSK gel SuperHZM-M” produced by Tosoh Corporation
“TSK gel SuperHZM-M” produced by Tosoh Corporation
“TSK gel SuperHZ-2000” produced by Tosoh Corporation
“TSK gel SuperHZ-2000” produced by Tosoh Corporation

Detector: RI (differential refractometer)

Data processing: “EcoSEC Data Analysis version 1.07” produced by Tosoh Corporation

Column temperature: 40° C.

Eluent: Tetrahydrofuran

Flow rate: 0.35 mL/min

Test sample: A test sample is prepared by dissolving 15 mg of a sample in 10 ml of tetrahydrofuran and filtering the resulting solution through a microfilter.

Amount of sample injected: 20 μl

Reference samples: The following monodisperse polystyrenes having known molecular weights are used in accordance with the instruction manual attached to the “HLC-8320GPC”.

### (Monodisperse Polystyrenes)

“A-300” produced by Tosoh Corporation

“A-500” produced by Tosoh Corporation

“A-1000” produced by Tosoh Corporation

“A-2500” produced by Tosoh Corporation

“A-5000” produced by Tosoh Corporation

“F-1” produced by Tosoh Corporation

“F-2” produced by Tosoh Corporation

“F-4” produced by Tosoh Corporation

“F-10” produced by Tosoh Corporation

“F-20” produced by Tosoh Corporation

“F-40” produced by Tosoh Corporation

“F-80” produced by Tosoh Corporation

“F-128” produced by Tosoh Corporation

“F-288” produced by Tosoh Corporation

The state of the polyester resin (A) varies depending on the number-average molecular weight (Mn), the composition, and the like thereof and is normally liquid, solid, paste-like, or the like at ordinary temperatures.

When the polyester resin (A) is a polyester resin produced by reacting the dibasic acid (a2) with the dihydric alcohol (a1), the polyester resin (A) includes a hydroxyl group or a carboxyl group at the ends. The hydroxyl group and the carboxyl group may be reacted with a compound including a reactive group capable of reacting with the hydroxyl group or the carboxyl group in order to endcap the polyester resin (A). Endcapping the polyester resin (A) may further enhance the preservation stability of the film including the modifying agent.

A modifying agent including an endcapped polyester resin (A) is preferably produced by, for example, any of the following methods:

Method 1: A method in which the dihydric alcohol (a1) including the dihydric alcohol represented by General Formula (2) above, the dibasic acid (a2), and a monocarboxylic acid are charged into a reaction system at a time and reacted with one another.

Method 2: A method in which the dihydric alcohol (a1) including the dihydric alcohol represented by General Formula (2) above and the dibasic acid (a2) are reacted with one another to form a polyester resin including a hydroxyl group at the ends, and the polyester resin is reacted with a monocarboxylic acid anhydride.

Method 3: A method in which the dihydric alcohol (a1) including the dihydric alcohol represented by General Formula (2) above, the dibasic acid (a2), and a monoalcohol are charged into a reaction system at a time and reacted with one another.

Method 4: A method in which the dihydric alcohol (a1) including the dihydric alcohol represented by General Formula (2) above and the dibasic acid (a2) are reacted with each other to form a polyester resin including a carboxyl group at the ends, and the polyester resin is reacted with a monoalcohol.

Examples of the monocarboxylic acid include aliphatic monocarboxylic acids and aromatic monocarboxylic acids. Examples of the aliphatic monocarboxylic acids include monocarboxylic acids having 2 to 9 carbon atoms, such as acetic acid, propanoic acid, butanoic acid, pentanoic acid, hexanoic acid, heptanoic acid, octanoic acid, 2-ethylhexanoic acid, and nonanoic acid; and anhydrides of the above aliphatic monocarboxylic acids. Examples of the aromatic monocarboxylic acids include benzoic acid, dimethylbenzoic acid, trimethylbenzoic acid, tetramethylbenzoic acid, ethylbenzoic acid, propylbenzoic acid, butylbenzoic acid, cumic acid, para-tert-butylbenzoic acid, ortho-toluic acid, meta-toluic acid, para-toluic acid, ethoxybenzoic acid, propoxybenzoic acid, naphthoic acid, nicotinic acid, furoic acid, and anisic acid; and methyl esters, acid chlorides, and the like of the above aromatic monocarboxylic acids. The above monocarboxylic acids may be used alone or in combination of two or more.

Examples of the monoalcohol include monoalcohols having 4 to 9 carbon atoms, such as 1-butanol, 2-butanol, isobutanol, t-butanol, 1-pentanol, isopentyl alcohol, tert-pentyl alcohol, cyclopentanol, 1-hexanol, cyclohexanol, 1-heptanol, 1-octanol, 2-ethyl-1-hexanol, isononyl alcohol, and 1-nonyl alcohol. The above monoalcohols may be used alone or in combination of two or more.

When the polyester resin (A) is endcapped, it is not necessary to cap all the carboxyl groups or hydroxyl groups included in the polyester resin (A) at the ends. That is, some of the carboxyl groups or hydroxyl groups may remain in the polyester resin (A) at the ends.

The acid value of the polyester resin (A) is preferably 3 or less and is more preferably 1 or less in order to impart high resistance to moisture permeation to the film and maintain the stability of the cellulose-ester-resin-modifying agent. The hydroxyl value of the polyester resin (A) is preferably 200 or less and is more preferably 150 or less.

The cellulose-ester-resin-modifying agent according to the present invention includes the polyester resin (A). The cellulose-ester-resin-modifying agent according to the present invention may be a modifying agent composed of only the polyester resin (A) or a modifying agent including the polyester resin (A) and polyesters other than the polyester resin (A). The cellulose-ester-resin-modifying agent may also include modifying agents other than polyesters. The cellulose-ester-resin-modifying agent may also include the unreacted portions of the raw materials used in the production of the polyester resin (A).

The modifying agent according to the present invention may be mixed with a cellulose ester resin to form a cellulose ester resin composition. By using the composition, an optical film having a phase retardation that does not vary significantly due to variations in humidity and being highly transparent and suitable for optical applications can be produced.

The cellulose ester resin may be produced by, for example, esterification of a part or all of the hydroxyl groups included in cellulose produced from cotton linters, wood pulp, kenaf, or the like. In particular, a film including a cellulose ester resin produced by esterification of cellulose produced from cotton linters is advantageous, because such a film can be easily removed from a metal support included in a film-production apparatus and the efficiency of film production is further increased accordingly.

Examples of the cellulose ester resin include cellulose acetates such as cellulose acetate, cellulose acetate propionate, cellulose acetate butyrate, and cellulose acetate phthalate; and cellulose nitrates. In the case where the cellulose ester optical film is used as a polarizing-plate protective film, cellulose acetates are preferably used in order to produce a film having excellent mechanical properties and high transparency. In particular, cellulose acetate propionate is more preferably used.

Examples of the cellulose acetates include cellulose triacetate and cellulose diacetate. Preferable examples of the cellulose acetate propionate include cellulose acetate propionates that satisfy the following two formulae:

2.2≦(X+Y)≦2.55 (1)

0≦(X)≦2.1 (2)

(where X represents the degree of substitution of acetyl groups and Y represents the degree of substitution of propionyl groups)

The number-average molecular weight (Mn) of the cellulose acetate is preferably 70,000 to 300,000 and is more preferably 80,000 to 200,000. Setting the (Mn) of the cellulose acetate to fall within the above range makes it possible to produce a film having excellent mechanical properties.

The content of the cellulose-ester-resin-modifying agent according to the present invention in the cellulose ester resin composition is preferably such that the amount of cellulose-ester-resin-modifying agent is 5 to 30 parts by mass relative to 100 parts by mass of the cellulose ester resin and is more preferably such that the amount of cellulose-ester-resin-modifying agent is 5 to 15 parts by mass relative to 100 parts by mass of the cellulose ester resin. Using the cellulose-ester-resin-modifying agent in an amount that falls within the above range makes it possible to produce a composition with which a film having a phase retardation that does not vary significantly due to variations in humidity and being highly transparent and suitable for optical applications can be produced.

A cellulose ester film including the cellulose ester resin and the cellulose-ester-resin-modifying agent according to the present invention is described below.

The cellulose ester film according to the present invention includes the cellulose ester resin, the cellulose-ester-resin-modifying agent, and, as needed, other various additives and the like. The cellulose ester film may be suitable for optical applications, that is, as a cellulose ester optical film. The thickness of the cellulose ester film according to the present invention varies depending on the application and is generally 10 to 200 μm.

The cellulose ester film according to the present invention may be produced using a cellulose ester resin composition including the cellulose ester resin and the cellulose-ester-resin-modifying agent.

The cellulose ester optical film may have a characteristic such as an optical anisotropy or an optical isotropy. In the case where the optical film is used as a polarizing-plate protective film, a film having an optical isotropy, which does not block light from passing through the film, is preferably used.

The cellulose ester optical film may be used in various applications. One of the applications in which the cellulose ester optical film is most advantageously used is, for example, a polarizing-plate protective film included in a liquid crystal display apparatus which requires an optical isotropy. The cellulose ester optical film may also be used as a support included in the polarizing-plate protective film which requires an optical compensation property.

The cellulose ester optical film may be used in various liquid crystal cells that are operated in different display modes. Examples of the display modes include IPS (in-plane switching), TN (twisted nematic), VA (vertically aligned), and OCB (optically compensatory bend).

The content of cellulose-ester-resin-modifying agent according to the present invention in the cellulose ester optical film according to the present invention is preferably such that the amount of cellulose-ester-resin-modifying agent is 5 to 30 parts by mass relative to 100 parts by mass of the cellulose ester resin and is more preferably such that the amount of cellulose-ester-resin-modifying agent is 5 to 15 parts by mass relative to 100 parts by mass of the cellulose ester resin. Using the cellulose-ester-resin-modifying agent in an amount that falls within the above range makes it possible to produce a film having a phase retardation that does not vary significantly due to variations in humidity and being highly transparent and suitable for optical applications.

The cellulose ester optical film may be produced by, for example, melt extrusion. Specifically, the cellulose ester optical film may be produced by melt-kneading a cellulose ester resin composition including the cellulose ester resin, the cellulose-ester-resin-modifying agent, and, as needed, other additives and the like with an extruder or the like and forming the kneaded composition into a film with a T-die or the like. Alternatively, the cellulose ester resin composition may be used instead of the cellulose ester resin and the cellulose-ester-resin-modifying agent.

The cellulose ester optical film may also be produced by a method other than the above-described one. An example of the other method is “solvent casting”, in which a resin solution prepared by dissolving the cellulose ester resin and the cellulose-ester-resin-modifying agent in an organic solvent is casted on a metal support, the organic solvent is removed by distillation, and drying is subsequently performed.

Employing solvent casting reduces the likelihood of irregularities being formed in the surface of the film and enables a film having a highly flat and smooth surface to be produced. Therefore, a film produced by solvent casting is preferably used in optical applications and is particularly preferably used as a polarizing-plate protective film.

In general, solvent casting includes the following three steps: a first step in which the cellulose ester resin and the cellulose-ester-resin-modifying agent are dissolved in an organic solvent, and the resulting resin solution is casted on a metal support; a second step in which the organic solvent included in the casted resin solution is removed by distillation, and drying is subsequently performed in order to form a film; and a third step in which the film formed on the metal support is removed from the metal support and subsequently heat-dried.

Examples of the metal support used in the first step include endless-belt-like metal supports and drum-like metal supports. For example, a stainless steel support having a mirror-finished surface may be used.

The resin solution is preferably filtered before being casted on the metal support in order to prevent foreign matter from mixing into the film.

The method for performing drying in the second step is not limited. Drying may be performed by, for example, blowing air having a temperature of 30° C. to 50° C. on the upper and/or lower surface of the metal support such that 50% to 80% by mass of the organic solvent included in the casted resin solution is evaporated and a film is formed on the metal support.

In the third step, the film formed in the second step is removed from the metal support and heat-dried at a temperature higher than the second step. For heat-drying the film, the temperature is preferably increased, for example, from 100° C. to 160° C. in stages in order to achieve good dimensional stability. Heat-drying the film under the above temperature conditions enables the organic solvent that remains in the film after the second step to be substantially completely removed.

In the first to third steps, the organic solvent may be collected and reused.

The type of the organic solvent that can be used in the step in which the cellulose ester resin and the cellulose-ester-resin-modifying agent are mixed and dissolved in an organic solvent is not limited, and any organic solvent in which the cellulose ester resin and the cellulose-ester-resin-modifying agent are soluble may be used. For example, in the case where cellulose acetate is used as a cellulose ester, it is preferable to use a good solvent such as an organic halogen compound (e.g., methylene chloride) or a dioxolane.

It is preferable to use a poor solvent such as methanol, ethanol, 2-propanol, n-butanol, cyclohexane, or cyclohexanone in combination with the good solvent in order to increase the efficiency of film production.

The mixing ratio of the good solvent to the poor solvent is preferably, by mass, good solvent/poor solvent=75/25 to 95/5.

The concentration of the cellulose ester resin in the resin solution is preferably 10% to 50% by mass and is more preferably 15% to 35% by mass.

In solvent casting, a fourth step in which the film that has been heat-dried in the third step is heat-stretched may optionally be conducted.

In the fourth step, a film produced using the cellulose ester resin composition according to the present invention through the first to third steps is heat-stretched. The film may be stretched in multiple steps. The film may be biaxially stretched in the casting and width directions. In the case where the film is biaxially stretched, the film may be stretched in two directions simultaneously or in stages. Stretching the film in two directions in stages means that the film is stretched in the two directions sequentially or the film is stretched in one direction in multiple steps and further stretched in the other direction in any of the multiple steps.

For biaxially stretching the film simultaneously, after the film has been stretched in one direction, a reduced tension may be applied to the film such that the film is contracted in the other direction. The stretching factors of simultaneous biaxial stretching are preferably, for example, 1.05 to 1.5 times in the width direction and 0.8 to 1.3 times in the longitudinal direction (i.e., the casting direction), are more preferably 1.1 to 2.5 times in the width direction and 0.8 to 0.99 times in the longitudinal direction, and are particularly preferably 1.1 to 2.0 times in the width direction and 0.9 to 0.99 times in the longitudinal direction.

The cellulose ester optical film may optionally include various additives as long as the advantageous effects of the present invention are not impaired.

Examples of the additives include various modifying agents other than the cellulose-ester-resin-modifying agent according to the present invention, a thermoplastic resin, an ultraviolet absorber, a matting agent, antidegradants (e.g., an antioxidant, a peroxide decomposer, a radical inhibitor, a metal deactivator, and an acid-acceptor), and a dye. The above additives may be used in combination with the cellulose ester resin and the cellulose-ester-resin-modifying agent when they are mixed and dissolved in the organic solvent. Alternatively, the above additives may be used at a timing other than the addition of the cellulose ester resin and the cellulose-ester-resin-modifying agent. That is, the timing at which the above additives are used is not limited.

Examples of the various modifying agents other than the cellulose-ester-resin-modifying agent include phosphoric acid esters such as triphenyl phosphate (TPP), tricresyl phosphate, and cresyl diphenyl phosphate; phthalic acid esters such as dimethyl phthalate, diethyl phthalate, dibutyl phthalate, and di-2-ethylhexyl phthalate; ethyl phthalyl ethyl glycolate; butyl phthalyl butyl glycolate; trimethylolpropane tribenzoate; pentaerythritol tetraacetate; and acetyl tributyl citrate.

Examples of the thermoplastic resin include, but are not limited to, a polyester resin other than the cellulose-ester-resin-modifying agent according to the present invention, a polyesterether resin, a polyurethane resin, an epoxy resin, and a toluenesulfonamide resin.

Examples of the ultraviolet absorber include, but are not limited to, oxybenzophenones, benzotriazoles, salicylic acid esters, benzophenones, cyanoacrylates, and nickel complex salts. The amount of the ultraviolet absorber is preferably 0.01 to 2 parts by mass relative to 100 parts by mass of the cellulose ester resin.

Examples of the matting agent include silicon oxide, titanium oxide, aluminium oxide, calcium carbonate, calcium silicate, aluminium silicate, magnesium silicate, calcium phosphate, kaolin, and talc. The amount of the matting agent is preferably 0.1 to 0.3 parts by mass relative to 100 parts by mass of the cellulose ester resin.

The type, the content, and the like of the dye are not limited as long as the advantageous effects of the present invention are not impaired.

The thickness of the cellulose ester optical film is preferably 5 to 120 μm, is more preferably 8 to 100 μm, and is particularly preferably 10 to 80 μm. In the case where the optical film is used as a polarizing-plate protective film, setting the thickness of the cellulose ester optical film to 10 to 80 μm advantageously makes it possible to produce a liquid crystal display apparatus having a small thickness and to maintain a sufficiently high strength, high Rth stability, high resistance to moisture permeation, and the like of the film.

The above-described cellulose ester optical film and the polarizing-plate protective film, which have a phase retardation that does not vary significantly due to variations in humidity and being highly transparent, may be used as an optical film included in a liquid crystal display apparatus, a support included in a photosensitive material for silver halide photography, or the like. Examples of the optical film include, but are not limited to, a polarizing-plate protective film, a retardation film, a reflection plate, a viewing angle improvement film, an antiglare film, an antireflection film, an antistatic film, and a color filter.

### EXAMPLES

The present invention is described more specifically on the basis of Examples below. In Examples, all “parts” and are on a mass basis unless otherwise specified.

### Example 1

### Cellulose-Ester-Resin-Modifying Agent According to the Present Invention

Into a four-necked flask having a volume of 0.5 liters which was equipped with a thermometer, a stirrer, and a reflux condenser, 216 g of hydrogenated bisphenol A, 142 g of succinic acid, 62 g of n-butanol, and 0.01 g of tetraisopropyl titanate, which served as an esterification catalyst, were charged. The resulting mixture was heated to 220° C. in stages while being stirred under a stream of nitrogen. The reaction was conducted for 15 hours in total. Thus, a polyester resin having a structure represented by General Formula (1), that is, a cellulose-ester-resin-modifying agent (1) according to the present invention, was prepared. The cellulose-ester-resin-modifying agent (1) was solid at ordinary temperatures and had an acid value of 0.89, a hydroxyl value of 4, and a number-average molecular weight of 1,400.

### Example 2

### Cellulose-Ester-Resin-Modifying Agent According to the Present Invention

Into a four-necked flask having a volume of 0.5 liters which was equipped with a thermometer, a stirrer, and a reflux condenser, 288 g of hydrogenated bisphenol A, 106 g of succinic acid, and 0.01 g of tetraisopropyl titanate, which served as an esterification catalyst, were charged. The resulting mixture was heated to 220° C. in stages while being stirred under a stream of nitrogen. The reaction was conducted for 20 hours in total. Thus, a polyester resin having a structure represented by General Formula (1), that is, a cellulose-ester-resin-modifying agent (2) according to the present invention, was prepared. The cellulose-ester-resin-modifying agent (2) was solid at ordinary temperatures and had an acid value of 0.65, a hydroxyl value of 94, and a number-average molecular weight of 1,100.

### Example 3

### Cellulose-Ester-Resin-Modifying Agent According to the Present Invention

Into a four-necked flask having a volume of 0.5 liters which was equipped with a thermometer, a stirrer, and a reflux condenser, 240 g of hydrogenated bisphenol A, 7 g of propylene glycol, 89 g of succinic acid, 61 g of benzoic acid, and 0.01 g of tetraisopropyl titanate, which served as an esterification catalyst, were charged. The resulting mixture was heated to 220° C. in stages while being stirred under a stream of nitrogen. The reaction was conducted for 24 hours in total. Thus, a polyester resin having a structure represented by General Formula (1), that is, a cellulose-ester-resin-modifying agent (3) according to the present invention, was prepared. The cellulose-ester-resin-modifying agent (3) was solid at ordinary temperatures and had an acid value of 0.52, a hydroxyl value of 25, and a number-average molecular weight of 920.

### Example 4

### Cellulose-Ester-Resin-Modifying Agent According to the Present Invention

Into a four-necked flask having a volume of 0.5 liters which was equipped with a thermometer, a stirrer, and a reflux condenser, 250 g of the cellulose-ester-resin-modifying agent (2) and 48 g of acetic anhydride were charged. The resulting mixture was heated to 120° C. in stages while being stirred under a stream of nitrogen. The reaction was conducted for 4 hours in total. Thus, a polyester resin having a structure represented by General Formula (1), that is, a cellulose-ester-resin-modifying agent (4) according to the present invention, was prepared. The cellulose-ester-resin-modifying agent (4) was solid at ordinary temperatures and had an acid value of 0.50, a hydroxyl value of 2, and a number-average molecular weight of 1,200.

### Example 5

### Cellulose-Ester-Resin-Modifying Agent According to the Present Invention

Into a four-necked flask having a volume of 0.5 liters which was equipped with a thermometer, a stirrer, and a reflux condenser, 216 g of hydrogenated bisphenol A, 10 g of propylene glycol, 53 g of succinic acid, 110 g of benzoic acid, and 0.02 g of tetraisopropyl titanate, which served as an esterification catalyst, were charged. The resulting mixture was heated to 220° C. in stages while being stirred under a stream of nitrogen. The reaction was conducted for 24 hours in total. Thus, a polyester resin having a structure represented by General Formula (1), that is, a cellulose-ester-resin-modifying agent (5) according to the present invention, was prepared. The cellulose-ester-resin-modifying agent (5) was solid at ordinary temperatures and had an acid value of 0.33, a hydroxyl value of 5.3, and a number-average molecular weight of 600.

### Example 6

### Cellulose Ester Film According to the Present Invention

A dope solution was prepared by dissolving 100 parts of cellulose acetate propionate (CAP-482-20, produced by Eastman Chemical Company, the degree of substitution of acetyl groups: 0.2, the degree of substitution of propionyl groups: 2.5, the degree of substitution of hydroxyl groups: 0.3, number-average molecular weight: 75,000, hereinafter abbreviated as “CAP”) and 10 parts of the cellulose-ester-resin-modifying agent (1) in 670 parts of dichloromethane. The dope solution was casted on a glass plate such that the casted dope solution had a thickness of 0.75 mm. The casted dope solution was dried at room temperature for 16 hours, at 50° C. for another 30 minutes, and at 100° C. for another 30 minutes in this order to form a cellulose ester film (1A) according to the present invention which had a thickness of 80μ. The cellulose ester film (1A) was uniaxially heat-stretched with a biaxial heat-stretching machine (produced by Imoto Machinery Co., Ltd.) under the following conditions: stretching temperature: a temperature 20° C. higher than the Tg of a mixture consisting of 100 parts of CAP and 10 parts of the cellulose-ester-resin-modifying agent (1); stretching factor: 1.5 times in the width direction (i.e., the direction perpendicular to the casting direction); stretching speed: 30 mm/min. Thus, a stretched cellulose ester film (1B) having a thickness of 70μ was prepared. The conditions under which the Tg of the mixture was determined are described below. The mixture consisting of 100 parts of CAP and 10 parts of the cellulose-ester-resin-modifying agent (1) had a Tg of 117° C.

### <Method for Determining Tg>

DSC822e produced by Mettler-Toredo was used. Into the exclusive aluminium pan of DSC822e, about 5 mg of the mixture was charged. Subsequently, the temperature was increased from 25° C. to 200° C. at 10° C./min (1st run). After the temperature was reduced to 0° C. at 10° C./min, the temperature was again increased to 200° C. at 10° C./min (2nd run). The intermediate glass transition point measured in the 2nd run was considered to be the glass transition point (Tg) of the mixture.

The birefringence of the cellulose ester film (1A) in the thickness direction and a change in the birefringence of the cellulose ester film (1A) in the thickness direction which occurred when the cellulose ester film (1A) was placed in a high-humidity environment were measured. A change in the dimensions of the cellulose ester film (1B) due to a change in humidity was measured. The haze values of the cellulose ester film (1A) and the cellulose ester film (1B) (i.e., the haze value of the film that had not yet been stretched and the haze value of the film that had been stretched) were also measured in order to determine a change in the haze value of the film due to stretching. The birefringence of the film in the thickness direction, a change in the birefringence of the film in the thickness direction, a change in the dimensions of the film due to a change in humidity, and a change in the haze value of the film due to stretching were measured by the following methods. Table 1 summarizes the evaluation results.

### <Method for Measuring Birefringence in Thickness Direction>

The phase retardation of the cellulose ester film (1A) at 550 nm was measured with KOBRA-WR (produced by Oji Scientific Instruments Co., Ltd.). A value obtained by subtracting the thickness of the film from the phase retardation of the film was considered to be the birefringence value, that is, out-of-plane phase retardation (Rth), of the cellulose ester film (1A). Rth represents a value defined by the following formula:

Rth (nm)=Out-of-Plane Birefringence (ΔP)×Thickness d (nm)

ΔP is calculated by “ΔP=[(Nx+Ny)/2]−Nz”, where Nx represents the refractive index of the film along the slow axis in the film plane, Ny represents the refractive index of the film along the fast axis in the film plane, and Nz represents the refractive index of the film in the thickness direction.

<Method for Determining Change in Birefringence which Occurred when Film was Placed in High-Humidity Environment>

The birefringence of the cellulose ester film (1A) that had been left to stand in an environment of 23° C. and 65% RH for 0.5 hours and the birefringence of the cellulose ester film (1A) that had been left to stand in an environment of 23° C. and 40% RH for 0.5 hours were measured. The difference between the two birefringences was divided by the birefringence of the cellulose ester film (1A) that had been left to stand in an environment of 23° C. and 40% RH for 0.5 hours, and the absolute value of the quotient was considered to be the change in birefringence (%). The smaller the change in the birefringence of the film, the smaller the variations in the phase retardation of the film due to variations in humidity.

### <Method for Determining Change in Dimensions Due to Change in Humidity>

As a change in the dimensions of the film due to a change in humidity, the degree of expansion of the sample, that is, the cellulose ester film (1B), which was caused by changing the humidity of the environment of the sample from 20% RH to 80% RH and the degree of contraction of the sample which was caused by changing the humidity of the environment of the sample, which had expanded since the humidity of the environment had been changed from 20% RH to 80% RH, from 80% RH to 20% RH were measured. Specifically, a sample film having a length of 20 mm and a width of 3 mm was cut from the cellulose ester film (1B) such that the stretching direction was the longitudinal direction of the sample film. The measurement equipment used was a thermomechanical analyzer TMA/SS6100 (produced by Seiko Instruments Inc.) equipped with a thermostat-hygrostat-capable humidity control unit. The measurement was conducted under the following conditions: measurement mode: tensile mode, load: 50 mN, chuck-to-chuck distance: 20 mm.

In the measurement, while the temperature of the sample placed in a furnace was maintained to be 40° C., the humidity was increased from 20% RH to 80% RH at a rate of 2% RH per minute and the elongation of the distance between the chucks was measured. The percentage of the elongation of the sample with respect to the initial distance between the chucks, which was measured at the beginning of the measurement, was calculated. The largest of the measured elongations was considered to be the expansion of the sample.

After the humidity was increased from 20% RH to 80% RH, while the temperature of the sample placed in the furnace was maintained to be 40° C., the humidity was reduced from 80% RH to 20% RH at a rate of 2% RH per minute and the distance between the chucks was measured. The percentage of the shrinkage of the sample with respect to the initial distance between the chucks, which was measured at the beginning of the measurement, was calculated. The largest of the measured shrinkages was considered to be the contraction of the sample.

The smaller the expansion of the film, the smaller the change in the dimensions of the film with an increase in humidity. That is, the cellulose ester film has high dimensional stability. The closer to zero the absolute value of the contraction of the film, the higher the ability of the expanded cellulose ester film to restore the original dimensions. That is, the smaller the expansion of the cellulose ester film and the closer to zero the absolute value of the contraction of the film, the higher the dimensional stability of the film.

### <Method for Determining Change in Haze Value Due to Stretching>

The difference between the haze value of the stretched film and the haze value of the film that had not yet been stretched was determined with a haze meter NDH5000 (produced by Nippon Denshoku Industries Co., Ltd.). The smaller the haze value of the film, the higher the transparency of the film. The smaller the difference between the haze value of the stretched film and the haze value of the film that had not yet been stretched, the smaller the change in the haze value of the film due to stretching.

### Example 7

### Cellulose Ester Film According to the Present Invention

A cellulose ester film (2A) and a cellulose ester film (2B) were prepared as in Example 5, except that 10 parts of the cellulose-ester-resin-modifying agent (1) used in Example 5 was changed to the cellulose-ester-resin-modifying agent (2). The cellulose ester films (2A) and (2B) were evaluated as in Example 5. Table 1 summarizes the results. A composition consisting of 10 parts of the cellulose-ester-resin-modifying agent (2) and 100 parts of CAP had a Tg of 117° C.

### Example 8

### Cellulose Ester Film According to the Present Invention

A cellulose ester film (3A) and a cellulose ester film (3B) were prepared as in Example 5, except that 10 parts of the cellulose-ester-resin-modifying agent (1) used in Example 5 was changed to the cellulose-ester-resin-modifying agent (3). The cellulose ester films (3A) and (3B) were evaluated as in Example 5. Table 1 summarizes the results. A composition consisting of 10 parts of the cellulose-ester-resin-modifying agent (3) and 100 parts of CAP had a Tg of 117° C.

### Example 9

### Cellulose Ester Film According to the Present Invention

A cellulose ester film (4A) and a cellulose ester film (4B) were prepared as in Example 5, except that 10 parts of the cellulose-ester-resin-modifying agent (1) used in Example 5 was changed to the cellulose-ester-resin-modifying agent (4). The cellulose ester films (4A) and (4B) were evaluated as in Example 5. Table 1 summarizes the results. A composition consisting of 10 parts of the cellulose-ester-resin-modifying agent (4) and 100 parts of CAP had a Tg of 118° C.

### Example 10

### Cellulose Ester Film According to the Present Invention

A cellulose ester film (5A) and a cellulose ester film (5B) were prepared as in Example 5, except that 10 parts of the cellulose-ester-resin-modifying agent (1) used in Example 5 was changed to the cellulose-ester-resin-modifying agent (5). The cellulose ester films (5A) and (5B) were evaluated as in Example 5. Table 1 summarizes the results. A composition consisting of 10 parts of the cellulose-ester-resin-modifying agent (5) and 100 parts of CAP had a Tg of 115° C.

TABLE 1

| | | | | | Example |
|---|---|---|---|---|---|
| | Example 6 | Example 7 | Example 8 | Example 9 | 10 |
| Cellulose-ester-resin-modifying agent | (1) | (2) | (3) | (4) | (5) |
| Birefringence (×10⁻⁴, 550 nm) | 27.7 | 30.6 | 33.1 | 30.5 | 40.5 |
| Change in birefringence in thickness | 4.8 | 4.3 | 3.1 | 3.2 | 3.1 |
| direction due to change in humidity (%) | | | | | |
| Expansion (%) | 0.08 | 0.10 | 0.10 | 0.10 | 0.1 |
| Contraction (%) | 0 | 0.01 | −0.02 | 0 | 0 |
| Haze value (before stretching) | 0.8 | 0.73 | 0.8 | 0.74 | 0.8 |
| Haze value (after stretching) | 0.98 | 1.11 | 1.15 | 1.42 | 0.95 |
| Change in haze value (after stretching − | 0.18 | 0.38 | 0.35 | 0.68 | 0.15 |
| before stretching) | | | | | |

### Comparative Example 1

### Comparative Cellulose-Ester-Resin-Modifying Agent

Into a four-necked flask having a volume of 3 liters which was equipped with a thermometer, a stirrer, and a reflux condenser, 648 g of phthalic anhydride, 132 g of adipic acid, 648 g of propylene glycol, 977 g of benzoic acid, and 0.07 g of tetraisopropyl titanate, which served as an esterification catalyst, were charged. The resulting mixture was heated to 220° C. in stages while being stirred under a stream of nitrogen. The reaction was conducted for 12 hours in total. Thus, a comparative polyester resin, that is, a comparative cellulose-ester-resin-modifying agent (1′), was prepared. The comparative cellulose-ester-resin-modifying agent (1′) was solid at ordinary temperatures and had an acid value of 0.07, a hydroxyl value of 8, and a number-average molecular weight of 420.

### Comparative Example 2

### Comparative Cellulose-Ester-Resin-Modifying Agent

Into a four-necked flask having a volume of 3 liters which was equipped with a thermometer, a stirrer, and a reflux condenser, 1490 g of succinic acid, 335 g of ethylene glycol, 410 g of propylene glycol, 453 g of n-butanol, and 0.16 g of tetraisopropyl titanate, which served as an esterification catalyst, were charged. The resulting mixture was heated to 220° C. in stages while being stirred under a stream of nitrogen. The reaction was conducted for 32 hours in total. Thus, a comparative polyester resin, that is, a comparative cellulose-ester-resin-modifying agent (2′), was prepared. The comparative cellulose-ester-resin-modifying agent (2′) was solid at ordinary temperatures and had an acid value of 0.43, a hydroxyl value of 2, and a number-average molecular weight of 1,200.

### Comparative Example 3

### Comparative Cellulose Ester Film

A comparative cellulose ester film (1′A) and a comparative cellulose ester film (1′B) were prepared as in Example 5, except that 10 parts of the cellulose-ester-resin-modifying agent (1) used in Example 5 was changed to the comparative cellulose-ester-resin-modifying agent (1′). The comparative cellulose ester films (1′A) and (1′B) were evaluated as in Example 5. Table 2 summarizes the results. A composition consisting of 10 parts of the comparative cellulose-ester-resin-modifying agent (1′) and 100 parts of CAP had a Tg of 123° C.

### Comparative Example 4

### Comparative Cellulose Ester Film

A comparative cellulose ester film (2′A) and a comparative cellulose ester film (2′B) were prepared as in Example 5, except that 10 parts of the cellulose-ester-resin-modifying agent (1) used in Example 5 was changed to the comparative cellulose-ester-resin-modifying agent (2′). The comparative cellulose ester films (2′A) and (2′B) were evaluated as in Example 5. Table 2 summarizes the results. A composition consisting of 10 parts of the comparative cellulose-ester-resin-modifying agent (2′) and 100 parts of CAP had a Tg of 112° C.

### Comparative Example 5

### Comparative Cellulose Ester Film

A comparative cellulose ester film (3′A) and a comparative cellulose ester film (3′B) were prepared as in Example 5, except that 10 parts of the cellulose-ester-resin-modifying agent (1) used in Example 5 was changed to sucrose benzoate. The comparative cellulose ester films (3′A) and (3′B) were evaluated as in Example 5. Table 2 summarizes the results. A composition consisting of 10 parts of sucrose benzoate and 100 parts of CAP had a Tg of 130° C.

### Comparative Example 6

### Comparative Cellulose Ester Film

A comparative cellulose ester film (4′A) and a comparative cellulose ester film (4′B) were prepared as in Example 5, except that addition of 10 parts of the cellulose-ester-resin-modifying agent (1) used in Example 5 was omitted. The comparative cellulose ester films (4′A) and (4′B) were evaluated as in Example 5. Table 2 summarizes the results. The Tg of CAP was 140° C.

TABLE 2

| | Comparative | Comparative | Comparative | Comparative |
|---|---|---|---|---|
| | Example 3 | Example 4 | Example 5 | Example 6 |
| Cellulose-ester-resin- | (1′) | (2′) | (3′) | None |
| modifying agent | | | | |
| Birefringence (×10⁻⁴, 550 nm) | 23.8 | 8.3 | 34.2 | 40.7 |
| Change in birefringence in | 7.1 | 9.8 | 6.5 | 9 |
| thickness direction due to | | | | |
| change in humidity (%) | | | | |
| Expansion (%) | 0.17 | 0.13 | 0.08 | 0.22 |
| Contraction (%) | 0.01 | 0.01 | −0.08 | 0 |
| Haze value (before stretching) | 0.82 | 0.66 | 1 | 0.86 |
| Haze value (after stretching) | 2.1 | 2.5 | 1.72 | 2.08 |
| Change in haze value (after | 1.28 | 1.84 | 0.72 | 1.22 |
| stretching − before stretching) | | | | |

Footnote of Table 2
(3′): Sucrose benzoate

The changes in the birefringences of the cellulose ester films prepared in Examples due to a change in humidity were small. Furthermore, the cellulose ester films were highly transparent. Thus, the cellulose ester films prepared in Examples were suitable for optical applications.

1. A polarizing-plate protective film comprising a cellulose-ester-resin-modifying agent and a cellulose ester resin, the cellulose-ester-resin-modifying agent including a polyester resin (A) having a backbone skeleton including a structure represented by General Formula (1): 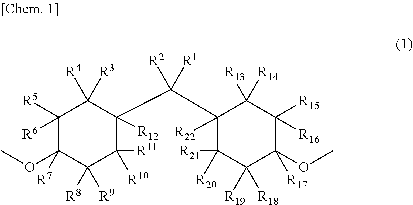
(wherein R¹ to R²² each represent a hydrogen atom, an alkyl group having 1 to 6 carbon atoms, a cycloalkyl group, or an aromatic group having 6 to 10 carbon atoms).

2. The polarizing-plate protective film according to claim 1, wherein, in General Formula (1), R¹ and R² each represent a methyl group, and R³ to R²² each represent a hydrogen atom or an alkyl group having 1 to 6 carbon atoms.

3. The polarizing-plate protective film according to claim 1, wherein, in General Formula (1), R¹ and R² each represent a methyl group, and R³ to R²² each represent a hydrogen atom.

4. The polarizing-plate protective film according to claim 1, wherein the polyester resin (A) is produced by reacting a dihydric alcohol (a1) with a dibasic acid (a2), the dihydric alcohol (a1) including a dihydric alcohol represented by General Formula (2): 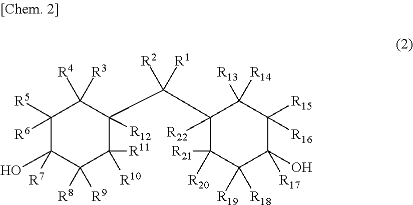
(wherein R¹ to R²² each represent a hydrogen atom, an alkyl group having 1 to 6 carbon atoms, a cycloalkyl group, or an aromatic group having 6 to 10 carbon atoms).

5. The polarizing-plate protective film according to claim 4, wherein, in General Formula (2), R¹ and R² each represent a methyl group, and R³ to R²² each represent a hydrogen atom or an alkyl group having 1 to 6 carbon atoms.

6. The polarizing-plate protective film according to claim 4, wherein, in General Formula (2), R¹ and R² each represent a methyl group, and R³ to R²² each represent a hydrogen atom.

7. The polarizing-plate protective film according to claim 4, wherein the dibasic acid (a2) is an aliphatic dibasic acid having 3 to 8 carbon atoms.

8. The polarizing-plate protective film according to claim 7, wherein the aliphatic dibasic acid is succinic acid or adipic acid.

9. The polarizing-plate protective film according to claim 4, wherein the amount of the alcohol represented by General Formula (2) is 5 to 100 parts by mass relative to 100 parts by mass of the dihydric alcohol (a1).

10. (canceled)

11. The polarizing-plate protective film according to claim 1, wherein the amount of the cellulose-ester-resin-modifying agent is 5 to 30 parts by mass relative to 100 parts by mass of the cellulose ester resin.

12. A method for producing a polarizing-plate protective film, the method comprising casting a resin solution on a metal support; removing the organic solvent by distillation; and subsequently performing drying, the resin solution being prepared by dissolving a cellulose-ester-resin-modifying agent and a cellulose ester resin in an organic solvent, the cellulose-ester-resin-modifying agent including a polyester resin (A) having a backbone skeleton including a structure represented by General Formula (1): 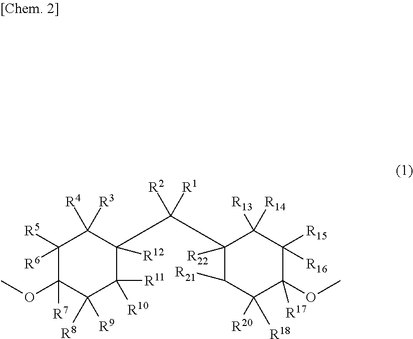
(wherein R¹ to R²² each represent a hydrogen atom, an alkyl group having 1 to 6 carbon atoms, a cycloalkyl group, or an aromatic group having 6 to 10 carbon atoms).

13. A liquid crystal display apparatus comprising the polarizing-plate protective film according to claim 1.

14. A liquid crystal display apparatus comprising the polarizing-plate protective film according to claim 2.

15. A liquid crystal display apparatus comprising the polarizing-plate protective film according to claim 3.

16. A liquid crystal display apparatus comprising the polarizing-plate protective film according to claim 4.

17. A liquid crystal display apparatus comprising the polarizing-plate protective film according to claim 5.

18. A liquid crystal display apparatus comprising the polarizing-plate protective film according to claim 6.

19. A liquid crystal display apparatus comprising the polarizing-plate protective film according to claim 7.

20. A liquid crystal display apparatus comprising the polarizing-plate protective film according to claim 8.

21. A liquid crystal display apparatus comprising the polarizing-plate protective film according to claim 9.
